(19) United States
(12) Patent Application Publication
(10) Pub. No.: US 2002/0058730 A1
(43) Pub. Date: May 16, 2002

(54) Resin composition for stencil ink and water-in-oil stencil ink

(76) Inventors: Yasunari Kawashima, Chiba (JP); Ichiro Muramatsu, Paramus, NJ (US); Koichi Okusawa, Ibaraki (JP); Yoshifumi Watanabe, Ibaraki (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/956,236

(22) Filed: Sep. 20, 2001

(30) Foreign Application Priority Data
Sep. 21, 2000 (JP) P. 2000-286905

(51) Int. Cl. C03C 17/00; C09D 5/00

(52) U.S. Cl. 523/160; 523/161

(57) ABSTRACT

A resin composition for stencil ink comprising: (I) a non-aqueous dispersion comprising; (a) a resin for dispersing; (b) a particulate resin comprising a film-forming linear acrylic resin, and (c) at least one solvent that can dissolve the resin (a) therein but cannot dissolve the particulate resin (b) therein, the solvent being selected from the group consisting of paraffinic hydrocarbon solvents, isoparaffinic hydrocarbon solvents and naphthenic hydrocarbon solvents; (II) a colorant; and (III) an emulsifying agent. Also disclosed is a water-in-oil stencil ink comprising the resin composition and water.

### FIELD OF THE INVENTION

The present invention relates to a resin composition for stencil ink comprising a non-aqueous dispersion, a pigment or dye and an emulsifying agent as essential components and a water-in-oil (W/O) type stencil ink comprising such a resin composition for stencil ink and water a essential components.

### BACKGROUND OF THE INVENTION

Stencil printing has long been widely used as an easy printing method. In recent years, with the automation of stencil plate making process, stencil printing has been further improved in its convenience and found wider application. As the stencil ink there has heretofore been widely used a W/O type emulsion ink from the standpoint of printability and handleability. In general, an emulsion ink obtained by kneading a resin with a colorant (coloring material), and then adding water to the mixture is used.

However, stencil printing is disadvantageous in that since drying after printing is accomplished mainly by the penetration of solvent and water into paper, the resulting printed matter has poor fixability.

In order to eliminate the foregoing disadvantage, JP-A-8-311387 (The term “JP-A” as used herein means an “unexamined published Japanese patent application”) discloses the incorporation of an O/W type acryl emulsion in the aqueous phase. However, this approach is disadvantageous in that when a stencil ink comprising such an O/W type acryl emulsion is used in printing by a printing machine, misting can easily occur. This approach is also disadvantageous in that when a large amount of such an O/W type acryl emulsion is added, the resulting ink undergoes solidification in the interior of the printing machine or the drum, causing clogging of the printing plate. Thus, the amount of the O/W type acryl emulsion to be incorporated is limited. Accordingly, this approach leaves something to be desired in fixability

It has thus been desired to develop a water-in-oil type stencil ink which gives a well-fixed printed matter without causing plate drying due to solidification of ink and misting during printing.

### SUMMARY OF THE INVENTION

It is therefore an object of the present invention to provide a resin composition for stencil ink which gives a well-fixed printed matter without causing plate drying due to solidification of stencil printing ink and misting during printing.

Another object of the present invention is to provide a water-in-oil type stencil ink comprising the resin composition.

Other objects and effects of the present invention will become apparent from the following description.

The inventors made extensive studios on the foregoing problems. As a result, it was found that the use of a resin composition for stencil ink comprising a non-aqueous dispersion comprising a resin for dispersing, a specific particulate resin and a hydrocarbon solvent which can dissolve the dispersing resin therein but cannot dissolve the particulate resin therein, a colorant and an emulsifying agent makes it possible to obtain a stencil ink which exhibits an improved fixability without causing plate drying and misting. The present invention has thus been worked out.

That is, the above-described objects of the present invention have been achieved by providing a resin composition for stencil ink comprising:

(I) a non-aqueous dispersion comprising: (a) a resin for dispersing component (b); (b) a particulate resin comprising a film-forming linear acrylic resin; and (c) at least one solvent that can dissolve said resin (a) therein but cannot dissolve said particulate resin (b) therein, said solvent being selected from the group consisting of paraffinic hydrocarbon solvents, isoparaffinic hydrocarbon solvents and naphthenic hydrocarbon solvents;

(II) a colorant; and

(III) an emulsifying agent.

The present invention also provides a water-in-oil type stencil ink comprising the foregoing resin composition for stencil ink and water as essential components.

### DETAILED DESCRIPTION OF THE INVENTION

The present invention is described in more detail below.

The non-aqueous dispersion (I) to be used in the invention comprises (a) a resin for dispersing, (b) a particulate resin made of a film-forming linear acrylic resin and (c) one or more solvents selected from the group consisting of paraffinic hydrocarbon solvents, isoparaffinic hydrocarbon solvents and naphthanic hydrocarbon solvents, which can dissolve said resin (a) therein but cannot dissolve the particulate resin b therein.

The resin (a) for dispersing is a resin which can be dissolved in the solvent (c) described below to cause the particulate resin (b) to be stably dispersed in the solvent (c). Any resin satisfying these conditions may be used. In practice, however, a resin having a relatively low polarity is used. Representative examples of the resin (a) include polymerized resin such as polyethylene, polypropylene, polybutadiene and acrylic resin, condensed resin such as alkyd resin, melamine resin, urea resin, phenolic resin, polyester resin and polyamide resin, acrylated alkyd resin, urethane resin, silicon resin, epoxy resin, cellulose resin, rosin-based resin, petroleum resin, and gilsonite.

Preferred among these resins, acrylic resin, alkyd resin and acrylated alkyd resin may be used to improve the fixability of the stencil ink. Particularly preferred among these resins are acrylic resin and acrylated alkyd resin. The term “acrylic resin” as used herein is meant to indicate a resin comprising an acrylic monomer as an essential component and optionally other copolymerizable monomers.

Representative examples of the acrylic monomer and other copolymerizable monomers to be used in the synthesis of the foregoing acrylic resin include various alkyl (meth)acrylates such as methyl (meth)acrylate, ethyl (meth)acrylate, propyl (meth)acrylate, iso-propyl (meth)acrylate, n-butyl (meth)acrylate, iso-butyl (meth)acrylate, tert-butyl (meth)acrylate sec-butyl (meth)acrylate, octyl (meth)acrylate, 2-ethylhexyl (meth)acrylate, lauryl (meth)acrylate, stearyl (meth)acrylate, 4-tert-butylcylohexyl (meth)acrylate, isobornyl (meth)acrylate, adamanthyl (meth)acrylate, benzyl (meth)acrylate and cyclohexyl (meth)acrylate, various alkoxyalkyl (meth)acrylates such as methoxyethyl (meth)acrylate, diester of various dicarboxylic acids such as dimethyl maleate, diethyl maleate, diethyl fumarate, dibutyl fumarate and dibutyl itaconate with monovalent alcohols, various vinylesters such as vinyl acetate and vinyl benzoate, various fluorine-containing polymerizable compounds such as perfluorocylohexyl (meth)acrylate, diperfluorocyclohexyl fumarate and N-iso-propylperfluorocctanesulfonamideethyl (meth)acrylate, various cyano-containing vinyl monomers such as (meth)acrylonitrile, various functional group-free halogenated olefins such as vinyl chloride, vinylidene chloride, vinyl fluoride and vinylidene fluoride, various hydroxyalkyl esters of α,β-ethylenically unsaturated carboxylic acid such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 3-chloro-2-hydroxypropyl (meth)acrylate, di-2-hydroxyethyl fumarate, mono-2-hydroxyethyl monobutyl fumarate, polyethylene glycol mono(meth)acrylate, polypropylene glycol mono (meth)acrylate and adduct thereof with ε-caprolactone, various unsaturated mono- or dicarboxylic acids such as (meth)acrylic acid, crotonic acid, maleic acid, fumaric acid, itaconic acid and citraconic acid and citraconic acid, various α,β-ethylenically unsaturated carboxylic acids such as monoester (half ester) of these dicarboxylic acids with monovalent alcohols, various hydroxyl-containing vinyl monomers such as hydroxyethyl vinyl ether, styrene monomers such as styrene, vinyl toluene, p-methylstyrene, ethylstyrene, propylstyrene, iso-propylstyrene and p-tert-butylstyrene, various amide bond-containing vinyl monomers such as (meth)acrylamide, dimethyl (meth)acrylamide, N-tert-butyl (meth)acrylamide, N-octyl (meth)acrylamide, diacetone acrylamide, dimethylaminopropyl acrylamide and alkoxylated N-methylolated (meth)acrylamide, various phosphorus-containing vinyl monomers such as diphenyl [(meth)acryloyloxyalkyl]phosphate, dialkyl[(meth) acryloyloxyalkyl]phosphate, (meth)acryloyloxyalkyl acid phosphate, dialkyl [(meth)acryloyloxyalkyl]phosphite, (meth) acryloyloxyalkyl acid phosphite and 3-chloro-2-acid phosphoxypropyl (meth)acrylate, various dialkylaminoalkyl (meth)acrylates such as dimethylaminoethyl (math)acrylate and diethylaminoethyl (meth)acrylate, α,β-ethylenically unsaturated carboxylic acids such as glycidyl (meth)acrylate, β-methyl)glycidyl (meth)acrylate and (meth)allylglycidyl ether, various silicone monomers such as vinyl ethoxysilane, α-methacryloxypropyl trimethoxysilane and trimethylsiloxyethyl (meth)acrylate, and various high molecular monomers (macromonomers or macromers) having copolymerizable functional terminals.

Examples of the alkyd resin employable herein include resins obtained by the reaction of polyvalent alcohols, polyvalent carboxylic acids or anhydride thereof and oils or fatty acids.

Examples of the polyvalent alcohols to be used in the synthesis of the foregoing alkyd resin include ethylene glycol, propylene glycol, glycerin, trimethylolethane, trimethylolpropane, neopentyl glycol, 1,16-hexanediol, 1,2,6-hexanetriol, pentaerythritol, and sorbitol.

Examples of the polyvalent carboxylic acids or anhydride thereof employable herein include phthalic acid, anhydride thereof, hexahydrophthalic acid, anhydride thereof, tetrahydrophthalic acids anhydride thereof, tetrachlorophthalic acid, anhydride thereof, hexachlorophthalic acid, anhydride thereof, tetrabromophthalic acid, anhydride thereof, trimellitic acid, succinic acid, anhydride thereof, maleic acid, anhydride thereof, fumaric acid, itaconic acid, anhydride thereof, adipic acid, sebacic acid, and oxalic acid.

Examples of the oils or fatty acids employable herein include various saturated fatty acids such as octyl acid, lauric acid and stearic acid, various unsaturated fatty acids such as oleic acid, linolic acid, linoleic acid, eleostearic acid and ricinolic acid, ,various drying oils, drying oil fatty acids, semi-drying oils or semi-drying oil fatty acids such as China wood oil, china wood oil fatty acid, linseed oil, linseed oil fatty acid, dehydrated castor oil, dehydrated castor oil fatty acid, tall oil, tall oil fatty acid, cottonseed oil, cottonseed oil fatty acid, soybean oil, soybean fatty acid, olive oil, olive oil fatty acid, safflower oil, safflower oil fatty acid, castor oil, castor oil fatty acid, rice-bran oil and rice-bran oil fatty acid, and various non-drying oils or non-drying oil fatty acids such as hydrogenated coconut oil, hydrogenated coconut oil fatty acid, coconut oil, coconut oil fatty acid, palm oil and palm oil fatty acid.

As the acrylated alkyd resin there may be used a resin obtained by modifying the foregoing alkyd resin with the previously mentioned acryl monomer. The term “modification” as used herein is meant to indicate that the acryl monomer or acryl polymer and the alkyd resin are chemically bonded to each other. Preferably, the acryl polymer and the alkyd resin are chemically bonded to each other. Examples of the chemical bond include graft bond, ester bond, urethane bond, urea bond, ether bond, amide bond, and siloxane bond. Of these, graft bond is preferred because it provides good productivity. In this case, the alkyd resin preferably has an unsaturated bond which acts as a basic point for graft bond. To this end, the foregoing drying oil, drying oil fatty acid, semi-drying oil or semi-drying fatty acid may be used as a starting material of alkyd resin to provide the alkyd resin with an unsaturated bond easily, The weight ratio of the total amount of acryl monomer to the solid content of alkyd resin (acryl monomer/alkyd resin) is preferably from 70/30 to 99/1, more preferably from 90/10 to 99/1. When the weight ratio of acryl monomer to alkyd resin exceeds 99/1, the resulting resin becomes substantially the same as acryl resin. On the contrary, when the weight ratio of acryl monomer to alkyd resin falls below 70/30, it becomes more likely that relation can occur during the preparation of acrylated alkyd resin.

In order that the resin (a) for dispersing can be dissolved in the solvent (c), it preferably has a relatively low polarity. To this end, the resin (a) preferably has a polarity of from 7.0 to 8.3 (cal/ml)^{½}, more preferably from 7.5 to 8.6 (cal/ml)/^{½} as calculated in terms of solubility parameter (hereinafter referred to as “SP value”).

The method for calculating SP value to be used herein will be outlined hereinafter, supposing that $P value of copolymer can be determined on the basis of additivity from SP value of various monomers by weight.

According to K. L. Hoy, “Journal of Paint Technology”, vol. 42, No. 541, page 76 (1970), SP value of various monomers are 9.35 for styrene, 9.23 for methyl methacrylate, 8.81 for ethyl acrylate, 8.63 for n-butyl methacrylate, 8.15 for iso-butyl methacrylate, 8.05 for t-butyl methacrylate and 7.87 for 2-ethylhexyl acrylate (unit: Cal/ml^{½}) For SP value of monomers which are not listed in references, the value calculated from the following equation ( supposing that the density is 1.0):

SP=(d·ΣG)/Mn

wherein SP represents SP (cal/ml)^{½} of monomer, d represents the density of monomer (g/ml); G represents molecular cohesion constant (cal-ml)^{½} L//mol; and Mn represents the molecular weight (g/mol) of monomer. As G values there are used those listed in Small, P. S., “J. Appl. Chem.3”, page 75 (1973).

Referring to the acrylic resin or acrylated alkyd resin to be used as the resin (a) for dispersing, as the acryl monomer there is preferably used ethyl (meth)acrylate, propyl (meth)acrylate, iso-propyl (meth)acrylate, n-butyl (meth)acrylate, iso-butyl (meth) acrylate, tert-butyl (meth) acrylate, sec-butyl (meth)acrylate, 2-ethylhexyl (meth)acrylate, octyl (meth)acrylate, lauryl (meth)acrylate, “Acrylester SL” (mixture of C12 methacrylate and C13 methacrylate produced by Mitsubishi Rayon Co., Ltd.), stearyl (meth)acrylate, 4-tert-butylcyclohexyl (meth) acrylate, isobonyl meth)acrylate, adamanthyl (meth)acrylate, benzyl (meth)acrylate, cyclohexyl (meth)acrylate or the like. Particularly preferred among these acryl monomers are (meth)acrylic acid esters the alkyl moiety of which has from 4 to 13 carbon atoms such as n-butyl (meth)acrylate, iso-butyl (meth) acrylate, tert-butyl (meth)acrylate, sec-butyl (meth)acrylate, 2-ethylhexyl (meth)acrylate, octyl (meth)acrylate, lauryl (meth)acrylate and “Acrylester SL” (mixture of C12 methacrylate and C13 methacrylate produced by Mitsubishi Rayon Co., Ltd.) because they can provide a non-aqueous dispersion having an excellent dispersion stability.

As the acrylic resin obtained from the foregoing (meth acrylic acid alkyl ester the alkyl moiety of which has from 4 to 13 carbon atoms there is preferably used an acrylic resin prepared from a starting material containing a (meth)acrylic acid alkyl ester the alkyl moiety of which has from 4 to 13 carbon atoms as an essential component in an amount of not smaller then 80% by weight. As the acrylated alkyd resin there is preferably used an acrylated alkyd resin prepared from a starting material containing a (meth)acrylic acid alkyl ester the alkyl moiety of which has from 4 to 13 carbon atoms as an essential component in an amount of from 80 to 95% by weight.

A stencil ink normally comprises a colorant such as pigment incorporated therein. Accordingly, the resin (a) for dispersing preferably has a high affinity for the colorant, To this end, the resin (a) preferably contains a polar group. Examples of such a polar group include amino group, phosphoric acid group, phosphoric acid ester group, hydroxyl group, and carboxylic acid group. Preferred among these polar groups are amino group and phosphoric acid ester group.

When as the resin (a) for dispersing there is used an acrylic resin, the amino group can be introduced from various dialkylaminoalkyl (meth)acrylates such as dimethylaminoethyl (meth)acrylate and diethylaminoethyl (meth)acrylate or various amide bond-containing vinyl monomers such as dimethyl (meth)acrylamide, N-tert-butyl (meth) acrylamide, diacetone acrylamide, dimethylaminopropyl acrylamide and alkoxylated N-methyolated (meth)acrylamide. The content of these compounds in the starting material to be used in the synthesis of the resin (a) for dispersing is normally from 0.1 to 20% by weight, particularly from 0.5 to 10% by weight.

The phosphoric acid group or phosphoric acid ester group can be introduced from diphenyl [(meth)acryloyloxyalkyl]phosphates such as diphenyl [methacryloyloxyethyl]phosphate, dialkyl [(meth) acryloyl oxyalkyl]phosphates such as dibutyl [methacryloyloxyethyl] phosphate, (meth)acryloyloxyalkyl acid phosphates such as methacrylcyloxyethyl acid phosphate, diphenyl[(meth) acryloyloxyalkyl]phosphites such as diphenyl[methacryloyloxyethyl]phosphite, dialkyl[(meth) acryloyloxyalkyl ]phosphites such as dibutyl [methacryloyloxyalkyl]phosphite, (methacryloyloxyalkyl acid phosphites such as methacryloyloxyethyl acid phosphite, etc. The content of these compounds in the total monomers to be used in the synthesis of the resin (a) for dispersing is normally from 0.1 to 20% by weight, particularly from 0.5 to 10% by weight.

The acrylic resin to be used as the resin (a) for dispersing can be obtained, e.g., by the radical polymerization of the foregoing various monomers for acrylic resin at a temperature of from 80° C. to 130° C. in the presence of various radical initiators in the solvent (c) described below. The acrylated alkyd resin having an acryl polymer and an alkyd resin graft-bonded to each other can be obtained, e.g., by the radical polymerization of the foregoing various monomers for acrylic resin at a temperature of from 80° C. to 130° C. in the presence of various radical initiators in the solvent (c) described below and an alkyd resin, preferably alkyd resin having an unsaturated bond. Further, the alkyd resin can be obtained, e.g., by the esterification of the foregoing starting material for alkyd resin at a temperature as high as from 180° C. to 250° C.

Examples of the radical initiators employable herein include various radical generating and polymerizing catalysts or radical polymerization initiators such as azobisisobutyronitrile (AIBN), benzoyl peroxide (BPO), tert-butyl perbenzoate (TBPB), tert-butyl hydroperoxide (TBHPO), di-tert-butyl peroxide (DTBPO) and cumen hydroperoxide (CHP). One or more of these radical initiators may be used.

As the particulate resin (b) there may be used a particulate resin made of a linear acrylic resin which cannot be dissolved in the solvent (c) but can be dispersed in the solvent (c) and cannot for a film in the solvent (c) but can form a film in the absence of the solvent (c).

It is necessary that the particulate resin (b) be no dissolved in the solvent (c) . The particulate resin (b) preferably has a high polarity. To this end, SP value of the particulate resin (b) is preferably from 8.5 to 12.0 (cal/ml)^{½}, particularly from 8.9 to 11.0 (cal/ml)^{½}. More preferably, SP value of the resin (a) for dispersing is not smaller than 0.2 (cal/ml)^{½} greater than that of the resin (a) for dispersing.

Examples of the acrylic resin to be used as the particulate resin (b) include monomers such as methyl (meth)acrylate, styrene, p-methylstyrene, 2-hydroxyethyl (meth)acrylate, (meth)acrylonitrile, (meth)acrylamide dimethylaminoethyl (meth)acrylate, glycidyl (meth)acrylate, and alkoxylated N-methylolated (meth)acrylamide.

In the inventions it is essential that the particulate resin (b) be a linear acrylic resin which cannot form a film in the presence of the solvent (c) but can form a film in the absence of the solvent (c). In order to improve the Fixability of the stencil ink, it is important that the resin component can form a film on the printing paper. When the particulate resin (b) is in the form of ink, the solvent (c) is present in the ink, making it impossible for the particulate resin (b) to form a film. Also when the ink is left on the drum, the solvent (c) is present, making it impossible for the particulate resin (b) to form a film. In other words, the printing plate is noted dried. However, when printing is made to cause the ink to be transferred to the printing paper, the solvent (c) immediately penetrate into the printing paper but the particulate resin (b) is left on the surface of the printing paper because it is particulate. Accordingly, the resin particles (b) are fused to each other on the printing paper to form a film, improving the fixability of the ink, When the particulate resin (b) is a crosslinked resin, the resin particles can difficultly be fused to each other even if the solvent (c) penetrates into the printing paper. Thus, the particulate rosin (b) forms no film, providing no improvement of fixability.

Stencil printing is normally conducted at a temperature of from 0° C. to 40° C. Thus, it is necessary that a film be formed within this temperature range. Accordingly, the glass transition temperature (hereinafter abbreviated as “Tg”) at which the particulate resin (b) forms a film is preferably from −20° C. to 50° C., more preferably from 0° C. to 40° C.

The method for calculating Tg is briefly described hereinafter. It is known that Tg of a copolymer obtained by copolymerization can be calculated from Tg of the various homopolymers and the weight proportion of the various monomers to be charged using the following Gordon-Taylor's equation. In the invention, too, Tg value calculated using this equation is employed. For Tg of homopolymers, values listed in POLYMER HANDBOOK (JOHN WILEY & SONS, INC.) are used.

Gordon-Taylor's equation:

1/Tg=Σ(Wn/Tgn)

wherein Tg represents Tg (K) of copolymer; Wn represents the weight fraction of monomer n; and Tgn represents Tg (K) of homopolymer of monomer n.

Specific examples of Tg value of homopolymer listed in POLYMER HANDBOOK will be given below.

| Monomer | Tg (K) of homopolymer | Tg (° C.) |
|---|---|---|
| t-Butyl methacrylate | 380 | 107 |
| 2-Ethylhexyl methacrylate | 263 | −10 |
| 2-Ethylhexyl acrylate | 223 | −50 |
| Methyl methacrylate | 378 | 105 |
| Ethyl acrylate | 249 | −24 |
| Styrene | 373 | 100 |
| Iso-butyl methacrylate | 326 | 53 |
| n-Butyl acrylate | 219 | −54 |
| iso-Butyl acrylate | 230 | −43 |
| Dimethylaminoethyl | 292 | 19 |
| methacrylate | | |

As the solvent (c) to be used in the non-aqueous dispersion (I) there may be used one or more solvents selected from the group consisting of paraffinic hydrocarbon solvent, isoparaffinic hydrocarbon solvent and naphthenic hydrocarbon solvent which can dissolve the resin (a) for dispersing therein but cannot dissolve the particulate resin (b) therein. Particularly preferred among these solvents is a mixture of paraffinic hydrocarbon solvent and naphthenic hydrocarbon solvent.

Particularly representative examples of the foregoing paraffinic hydrocarbon solvent, isoparaffinic hydrocarbon solvent and naphthenic hydrocarbon solvent employable herein include Marukasol R or E (paraffinic hydrocarbon solvent produced by Maruzen Petrochemical Co., Ltd.), Shellsol 70 or 71 (paraffinic hydrocarbon solvent produced by Showa Shell Sekiyu K.K.), Diana solvent No. 0 or No. 1 (paraffinic hydrocarbon solvent produced by Idemitsu Kosan Co., Ltd,), IF Solvent 1016 or 1020 (paraffinic hydrocarbon solvent produced by Idemitsu Kosan Co., Ltd.), AF Solvent (mixture of paraffinic hydrocarbon solvent and naphthenic hydrocarbon solvent produced by Nippon Mitsubishi Oil Co., Ltd.), Shellsol D-40 (mixture of paraffinic hydrocarbon solvent and naphthenic hydrocarbon solvent produced by Showa Shell Sekiyu K.K.), Exxsol 30, D-40, D-60 and D-70 (mixture of paraffinic hydrocarbon solvent and naphthenic hydrocarbon solvent produced by Exxon Chemical Inc.), Isopar C, E, G or H (isoparaffinic hydrocarbon solvent produced by Exxon Chemical Inc.), n-hexane, and n-heptane.

The proportion of the resin (a) for dispersing and the particulate resin (b) in the non-aqueous dispersion (I) is not specifically limited. In practice, however, the ratio of resin (a)/particulate resin (b) is preferably from 0.1/1 to 9/1, particularly from 0.4/1 to 4/1 by solid weight because a stable non-aqueous dispersion (I) can be formed and misting can difficultly occur during printing.

The non-aqueous dispersion (I) to be used in the invention is preferably a non-aqueous emulsion comprising a core-shell type dispersed particulate resin having the particulate resin (b) incorporated in the core thereof and the resin (a) incorporated in the shell thereof. The non-aqueous emulsion is obtained by mixing a monomer, which can; be dissolved in the solvent (c) but a resin obtained by the polymerization of which monomer cannot dissolved therein, with a radical initiator in the presence of the solvent (c) and the resin (a) dissolved in the solvent (c), and then subjecting the mixture to radical polymerization.

The average particle diameter of the core-shell type dispersed particulate resin dispersed in the non-aqueous dispersion (I) is preferably from 0.05 to 3 μm, particularly from 0.3 to 2 μm as determined by light scattering method because printing can be made without clogging the pares in the stencil printing plate.

As a light scattering method for measuring the average particle diameter of the core-shell type dispersed particulate resin dispersed in the non-aqueous dispersion (I) there may be used a method involving the use of a Type Microtrac UPA-150 light scattering type particle size analyzer produced by Leeds+Northrup Inc. with AF Solvent No. 7 as a measuring solvent.

The sum of the iodine values of the resin components consisting of the resin (a) for dispersing and the particulate resin (b) in the non-aqueous dispersion (I) is not specifically limited. In practice, however, the iodine value of the resin composition is preferably not greater than 100, particularly from 0 to 50 because the resulting stencil ink has a good stability and thus can difficultly undergo drying and solidification that causes clogging of the pores in the printing plate.

The amount of the foregoing non-aqueous dispersion (I) to be used is not limited. In practice, however, the sum of the content of the resin (a) for dispersing and the particulate resin (b) in the non-aqueous dispersion (I) in the nonvolatile content of the resin composition for stencil ink is preferably not smaller than 1.0% by weight, more preferably from 10 to 80% by weight, particularly from 20 to 70% by weight because a stencil ink having an excellent fixability can be obtained.

The resin composition for stencil ink of the invention comprises a colorant (XI) and an emulsifying agent (III) incorporated therein as essential components besides the non-aqueous dispersion (I). As other components to be incorporated in the resin composition for stencil ink there may be used any of known materials which can be commonly used for stencil ink. Examples of these components include resins other than resin (a) for dispersing and particulate resin (b), solvents, pigment dispersants, waxes and oxidation inhibitors.

Examples of the colorant (II)to be used herein include organic pigments such as azo-based pigment, cyanine-based pigment, dioxazine-based pigment and quinacridone-based pigment, inorganic pigments such as carbon black, titanium oxide, colcothar, chromate, ferrocyan compound, metal oxide, sulfide, selenide, sulfate, silicate, carbonate, phosphate, metal powder and pearl pigment, dyes such as oil-soluble dye and water-soluble dye, colored particulate polymers, and extender pigments such as calcium carbonate, bentonite, aluminum hydroxide, precipitated barium sulfate, barium carbonate, chalk, gypsum, alumina white, clay, silica, silica white, talc, calcium silicate and precipitated magnesium carbonate. Particularly preferred among these colorants is pigment. The amount of the pigment to be incorporated in the resin composition for stencil ink (or the nonvolatile content in the resin composition for stencil ink) is preferably not greater than 75% by weight, particularly from 5 to 40% by weight.

The emulsifying agent (III) is incorporated in the resin composition for stencil ink to form a W/O type stencil ink. The emulsifying agent (III) is not specifically limited but may be any of anionic surface active agent, cationic surface active agent, amphoteric surface active agent and nonionic surface active agent. Particularly preferred among these emulsifying agents is nonionic surface active agent. Examples of the nonionic surface active agent employable herein include sorbitan fatty acid ester such as sorbitan monolaurate, sorbitan monopalmitate, sorbitan monooleate, sorbitan sesquioleate, sorbitan monoisostearate and sorbitan tristearate, oxidized ethylene adduct of these sorbitan fatty ester (polyoxyethylene sorbitan fatty acid ester), (poly)glycerin fatty acid ester such as glyceryl monostearate, hexaglyceryl tetracleate, decaglyceryl decaoleate and hexaglyceryl pentaoleate, oxidized ethylene adduct of these (poly)glycerin fatty acid ester (polyoxyethyleneglycerin fatty acid ester). polyoxyethylene sorbit fatty acid ester, polyoxyethylene alkyl ether, polyoxyethylene polyoxypropylene alkyl ether, and polyoxyethylene (hardening) castor oil. These nonionic surface active agents may be used singly or in combination of two or more thereof. The content of these nonionic surface active agents to be incorporated in the resin composition for stencil ink (or the nonvolatile content of the resin composition for stencil ink) is preferably from 0.2 to 25% by weight, particularly from 2 to 10% by weight.

Examples of the resin to be used besides the resin (a) for dispersing and the particulate resin (b) include alkyd resin, rosin-modified alkyd resin, rosin-modified phenol resin, rosin ester resin, petroleum resin, oil and fat compound, modified oil and fat compound, gilsonite, polybutadiene, hydrogenated polybutadiene, acryl resin, melamine resin, urea resin, phenol resin, polyester resin, polyamide resin, urethane resin, silicone resin, epoxy rein, and cellulose resin.

Examples of the solvent employable herein include the solvent (c) to be used as a diluent solvent, other solvents which cannot dissolve the resin (a) therein, such as various alcohol-based solvents (e.g., methanol, ethanol, n-propanol, iso-propanol, n-butanol, iso-butanol), various ester-based solvents (e.g., ethyl acetate, n-butyl acetate, cellosolve acetate), various ketone-based solvents (e.g., methyl ethyl ketone, methyl isobutyl ketone) and various ether-based solvents (e.g., butyl cellosolve).

Examples of the pigment dispersant employable herein include nonionic surface active agent such as sorbitan fatty acid ester, polyglycerin fatty acid ester, fatty acid monoglyceride, fatty acid diglyceride and polyethylene oxide adduct of fatty acid, alkylamine-based polymer, aluminum chelate-based compound, styrene-maleic anhydride copolymer, partial alkylester of polyacrylic acid, polyalkylene polyamine, fatty acid polyvalent carboxylic acid, polyether, ester type anionic surface active agent, long-chain amine salt of high molecular polycarboxylic acid, polyamide, phosphoric acid ester-based surface active agent, alkylsulfocarboxylate, α-olefinsulfonic acid, and dioctylsultosuccinate. These pigment dispersants may be the same as the resins other than the resin (a) and the particulate resin (b). These pigment dispersants may be used singly or in combination of two or more thereof.

The wax is added for the purpose of improving the fixability of the printed image. Examples of the wax employable herein include paraffin wax, carnauba wax, microcrystalline wax, montan wax, shellac wax, beeswax, and low molecular branched polyethylene. The addition of these waxes makes it possible to obtain a printed matter having excellent fixability.

The oxidation inhibitor is added to inhibit the denaturation of the ink by the oxidation of resin or oil phase. Examples of the oxidation inhibitor employable herein include BHT (dibutylhydroxytoluene), propyl gallate, and butyl hydroxyanisole.

In order to obtain a W/O type stencil ink from the resin composition for stencil ink of the invention, other components may be optionally added to the non-aqueous dispersion (I), the colorant (II) and the emulsifying agent (III) to form an oil phase. Thus, a resin composition for stencil ink of the invention (oil phase) is obtained. To the oil phase is then gradually added the aqueous phase component to cause emulsification.

The term “aqueous phase” as used herein is meant to indicate a material essentially composed of water against the resin composition for stencil ink as oil phase in the W/O type stencil ink. The aqueous phase may further comprise an electrolytic material, a wetting agent, an mildewproofing agent, an oxidation inhibitor, etc. incorporated therein for the purpose of improving the stability of W/O type stencil ink. In particular, an aqueous phase comprising as an electrolytic material magnesium sulfate, sodium sulfate, sodium citrate, sodium dihydrogenphosphate, sodium borate and sodium acetate incorporated therein in an amount of from 0.1 to 2.0 parts by weight based on 100 parts by weight of water is preferred.

The present invention will be illustrated in greater detail with reference to the following examples and comparative examples, but the present invention should not be construed as being limited thereto. All the “parts” and “%” as used hereinafter are given by weight unless otherwise indicated.

### EXAMPLE 1

Preparation of Resin for Dispersing

In a four-neck flask equipped with an agitator, a thermometer, a condenser and a nitrogen gas intake pipe were charged 410 parts of AF Solvent No 7 (mixture of paraffinic hydrocarbon solvent and naphthenic hydrocarbon solvent produced by Nippon Mitsubishi Oil Co. Ltd.). The solvent was then heated to a temperature of 90° C. Subsequently, to the solvent were added dropwise a mixture of 300 parts of t-butyl methacrylate (hereinafter referred to as “tBMA”), 90 parts of 2-ethylhexyl methacrylate (hereinafter referred to as 2EHMA) and 90 parts of 2-ethylhexyl acrylate (hereinafter referred to as “2EHA”) and a mixture of 7-5 parts of “AF Solvent No. 7” and 7 parts of benzoyl peroxide (hereinafter referred to as “BPO”) in 4 hours. After the termination of dropwise addition, the reaction continued at the same temperature as mentioned above for 8 hours to obtain a transparent acrylic resin solution having a nonvolatile content of 50.0%, a Gardener viscosity of Z₂-Z₃ at 25° C. (the same hereinafter) and an SP value of 8.0.

Preparation of Non-aqueous Dispersion

In another four-neck flask were charged 550 parts (solid content: 275 parts) of the acrylic resin solution thus obtained and 117 parts of AF Solvent No. 7. The mixture was then heated to a temperature of 100° C. Subsequently, to the mixture were added dropwise a mixture of 120 parts of methyl methacrylate (hereinafter referred to as “MMA”) and 153 parts of ethyl acrylate (hereinafter referred to as “EA”) (copolymer comprising the mixture of MMA and EA has an SP value of 9.0 and Tg of 20° C.) and a mixture of 55 parts of AF Solvent No. 7 and 2 parts of BPO in 4 hours. Thereafter, the mixture was allowed to undergo reaction at the same temperature as mentioned above for 8 hours to obtain a non-aqueous dispersion (NAD-1) having a resin for dispersing/dispersed particulate resin solid weight ratio of 1/1, a nonvolatile content of 55.0% and a viscosity of Z₂. The non-aqueous dispersion (5NAD-1) comprised a core-shell type dispersed particulate resin having an average diameter of 0.8 μm as measured by light scattering method. The iodine value of the resin component comprising the resin for dispersing and the dispersed particulate resin in combination was 2.

Preparation of Resin Composition for Stencil Ink and Stencil Ink

44 parts of the non-aqueous dispersion NAD-l thus obtained, 10 parts of MA-100 (carbon black produced by Mitsubishi Chemical Corporation), 20 parts of AF Solvent No. 5 (mixture of paraffinic hydrocarbon solvent and naphthenic hydrocarbon solvent produced by Nippon Mitsubishi Oil Co., Ltd.) and 6 parts of Nikkol Decaglin 50 (decaglyceryl decaoleate as W/O emulsifying agent produced by Nikko chemicals Co., Ltd.) were thoroughly mixed to prepare a resin composition for stencil ink (oil phase) Subsequently, to the resin composition for stencil ink was added an aqueous phase comprising 1 part of magnesium sulfate and 119 parts of ion-exchanged water with stirring to cause emulsification. Thus, a W/O type stencil ink was obtained.

Evaluation of Stencil Ink

Using a stencil printing machine (Type GR375 RISOGRAPH, produced by RISO KAGAKU CORPORATION), the stencil ink thus obtained was subjected to stencil printing. As a printing paper there was used a thin paper produced by RISO KAGAKU CORPORATION. The stencil ink was then evaluated for misting, fixability and plate drying after printing according to the following methods. The results of evaluation are set forth in Table 1.

Evaluation method and criterion:

Misting: The printed matter obtained by the stencil printing machine was observed for misting. When no misting was observed, it was judged as G (good). When some misting was observed, it was judged as F (fair) When definite misting was observed, it was judged as P (poor).

Fixability test: Stencil printing was conducted using the stencil printing machine. The printed matter thus obtained was allowed to stand at room temperature for 1 day, and then was subjected to rubbing with a rubbing tester and visually observed for rubbing off. When little or no rubbing off was observed, it was nudged as G (good). When slight rubbing off was observed, it was judged as F (fair) When remarkable rubbing off was observed, it was judged as P (poor).

PlateDrum drying: Stencil printing was conducted using the stencil printing machine. The stencil printing machine was allowed to stand at room temperature for 1 month. Printing was again conducted using the stencil printing machine. The printed matter was then observed. When printing was made without drying on the printing plate, it was judged as G (good). When the printing plate was slightly dried, it was judged as F (fair). When the printing plate was definitely dried, it was judged as P

### EXAMPLE 2

Preparation of Resin for Dispersing

In a four-neck flask equipped with an agitator, a thermometer, a condenser and a nitrogen gas intake pipe were charged 557 parts of AF Solvent No.7. The solvent was then heated to a temperature of 90° C. Subsequently, to the solvent were added dropwise a mixture of 280 parts of styrene (hereinafter referred to as “St”), 200 parts of iso-butyl ethacrylate (hereinafter referred to as “iBMA”) and 170 parts of 2EHA and a mixture of 120 parts of AF solvent No. 7 and 27 parts of BPO in 4 hour. After the termination of dropwise addition, the reaction continued at the same temperature as mentioned above for 8 hours to obtain a transparent acrylic resin solution having a nonvolatile content of 50.0%, a Gardener viscosity of Z₅-Z₆ at 25° C. and an SP value of 8.5.

Preparation of Non-aqueous Dispersion

In another four-neck flask were charged 400 parts (solid content: 200 parts) of the acrylic resin solution thus obtained and 200 parts of AF Solvent No. 7. The mixture was then heated to a temperature of 100° C. Subsequently, to the mixture were added dropwise a mixture of 133 parts of MMA and 67 parts of n-butyl acrylate (hereinafter referred to as “BA”) (copolymer comprising the mixture of MMA and BA has an SP value of 9.0 and Tg of 30° C.) and a mixture of 19 parts of AF Solvent No. 7 and 5 parts of BPO in 4 hours. Thereafter, the mixture was allowed to undergo reaction at the same temperature as mentioned above for 8 hours to obtain a non-aqueous dispersion (NAD-2) having a resin for dispersing/dispersed particulate resin solid weight ratio of 1/1, a nonvolatile content of 49.0% and a viscosity of Z₆. The non-aqueous dispersion (NAD-2) comprised a core-shell type dispersed particulate resin having an average diameter of 1.0 μm as measured by light scattering method. The iodine value of the resin component comprising the resin for dispersing and the dispersed particuate resin in combination was 0.7.

Preparation of Resin Composition for Stencil Ink and Stencil Ink

A resin composition for stencil ink was prepared in the same manner as in Example 1 except that as the non-aqueous dispersion there were used 49 parts of NAD-2 thus obtained instead of 44 parts of NAD-1 and the amount of AF Solvent No. 5 was changed from 20 parts to 15 parts. The resin composition for stencil ink thus prepared was then processed in the same manner as in Example 1 to obtain a W/O type stencil ink.

Evaluation of Stencil Ink

Subsequently, the stencil ink was examined for misting, fixability and plate drying after printing in the same manner as in Example 1 except that the W/O type stencil ink thus obtained was used. The results of evaluation are set forth in Table 1.

### EXAMPLE 3

Preparation of Resin for Dispersing

In a four-neck flask equipped with an agitator, a thermometer, a condenser and a nitrogen gas intake pipe were charged 500 parts of Isopar E (isoparaffinic hydrocarbon solvent produced by Exxon Chemical Inc.). The solvent was then heated to a temperature of 100° C. Subsequently, to the solvent were added dropwise a mixture of 320 parts of tBMA, 480 parts of iBMA and 200 parts of 2EHA and a mixture of 500 parts of Isopar E and 10 parts of BPO in 4 hours, After the termination of dropwise addition, the reaction continued at the same temperature as mentioned above for 8 hours to obtain a transparent acrylic resin solution having a nonvolatile content of 50.0%, a viscosity of U and an SP value of 8.1.

Preparation of Non-aqueous Dispersion

In another four-neck flask were charged 600 parts (solid content: 300 parts) of the acrylic resin solution thus obtained. The solution was then heated to a temperature of 100° C. Subsequently, to the mixture were added dropwise a mixture of 393 parts of MMA and 307 parts of EA (copolymer comprising the solution of MMA and EA has an SP value of 9.0 and Tg of 35° C.) and a mixture of 700 parts of Isopar E and 7 parts of ESP in 4 hours. Thereafter, the mixture was allowed to undergo reaction at the same temperature as mentioned above for 8 hours to obtain a non-aqueous dispersion (NAD-3) having a resin for dispersing/dispersed particulate resin solid weight ratio of 0.43/1, a nonvolatile content of 500and a viscosity of O-P. The non-aqueous dispersion (NAD-3) comprised a core-shell type dispersed particulate resin having an average diameter of 2.0 μm as measured by light scattering method. The iodine value of the resin component comprising the resin for dispersing and the dispersed particulate resin in combination was 0.

Preparation of Resin Composition for Stencil Ink and Stencil Ink

A resin composition for stencil ink was prepared in the same manner as in example 1 except that as the non-aqueous dispersion there were used 48 parts of NAD-3 thus obtained instead of 44 parts of NAD-1 and the amount of AF Solvent No. 5 was changed from 20 parts to 16 parts. The resin composition for stencil ink thus prepared was then processed in the same manner as in Example i to obtain a W/O type stencil ink.

Evaluation of Stencil Ink

Subsequently, the stencil ink was examined for misting, fixability and plate drying after printing in the same manner as in Example 1 except that the W/O type stencil ink thus obtained was used. The results of evaluation are set forth in Table 1.

### EXAMPLE 4

Preparation of Resin for Dispersing

In a four-neck flask equipped with an agitator, a thermometer, a condenser and a nitrogen gas intake pipe were charged 336 parts of soybean oil, 484 parts of soybean oil fatty acid, 294 parts of pentaerythritol and 387 parts of phthalic anhydride The mixture was then gradually heated to a temperature of 240° C. so that the reaction proceeded while water was being removed until the acid value thereof reached 5 mgKOH/g. Subsequently, to the reaction solution were added 790 parts of AF Solvent No. 7 to obtain an alkyd resin having a nonvolatile content of 65% (ALK-1).

Preparation of Non-aqueous Dispersion

In another four-neck flask were charged 308 parts (solid content; 200 parts; SP value: 8.3) of ALK-1 as a resin for dispersing and 168 parts of A-F Solvent No. 7. The mixture was then heated to a temperature of 100° C. subsequently, to the mixture were added dropwise a mixture of 67 parts of MMA and 33 parts of BA (copolymer comprising the mixture of MMA and BA has an SP value of 9.0 and Tg of 50° C.) and a mixture of 20 parts of AF Solvent No. 7 and 4 parts of BPO in 4 hours. Thereafter, the mixture was allowed to undergo reaction at the same temperature as mentioned above for 8 hours to obtain a non-aqueous dispersion (NAD-4) having a resin for dispersing/dispersed particulate resin solid weight ratio of 2/1, a nonvolatile content of 50.0% and a viscosity of Z₃. The non-aqueous dispersion (NAD-4) comprised a core-shell type dispersed particulate resin having an average diameter of 0.5 Fan as measured by light scattering method. The iodine value of the resin component comprising the resin for dispersing and the dispersed particulate resin it combination was 40.

Preparation of Resin Composition for Stencil Ink and Stencil Ink

A resin composition for stencil ink was prepared in the same manner as in Example 1 except that as the non-aqueous dispersion there were used 48 parts of NAD-4 thus obtained instead of 44 parts of NAD-1 and the amount of AF Solvent No. 5 was changed from 20 parts to 16 parts. The resin composition for stencil ink thus prepared was then processed in the same manner as in Example 1 to obtain a W/O type stencil ink.

Evaluation of Stencil Ink

Subsequently, the stencil ink was examined for misting, fixability and plate drying after printing in the same manner as in Example 1 except that the W/O type stencil ink thus obtained was used. The results of evaluation are set forth in Table 1.

### EXAMPLE 5

Preparation of Resin for Dispersing

In a four-neck flask equipped with an agitator, a thermometer, a condenser and a nitrogen gas intake pipe were charged 408 parts of AF Solvent No. 7. The solvent was then heated to a temperature of 90° C. Subsequently, to the solvent were added dropwise a mixture of 293 parts of tBMA, 90 parts of 2EHMA, 86 parts of 2EHA and 10 parts of dimethylaminoethyl methacrylate and a mixture of 74 parts of AF Solvent No. 7 and 12 parts of BPO in 4 hours. After the termination of dropwise addition, the reaction continued at the same temperature as mentioned above for 8 hours to obtain a transparent acrylic resin solution having a nonvolatile content of 50.0%, a Gardener viscosity of Z-Z₁ at 25° C. and an SP value of 8.0.

Preparation of Non-aqueous Dispersion

In another four-neck flask were charged 771 parts (solid content: 386) of the acrylic resin thus obtained and 22 parts of AF Solvent No. 7. The mixture was then heated to a temperature of 100° C., Subsequently, to the mixture were added dropwise a mixture of 86 parts of MMA and 77 parts of BA (copolymer comprising the mixture of MMA and BA has an SP value of 8.9 and Tg of 7° C.) and a mixture of 38 parts of AF Solvent No. 7 and I part of BPO in 4 hours. Thereafter, the mixture was allowed to undergo reaction at the same temperature as mentioned above for 8 hours to obtain a non-aqueous dispersion (NAD-5) having a resin for dispersing/dispersed particulate resin solid weight ratio of 2.3/1, a nonvolatile content of 55.0% and a viscosity of Z₅-Z₆. The non-aqueous dispersion (NAD-5) comprised a core-shell type dispersed particulate resin having an average diameter of 0.7 μm as measured by light scattering method. The iodine value of the resin component comprising the resin for dispersing and the dispersed particulate resin in combination was 2.

Preparation of Resin Composition for Stencil Ink and Stencil Ink

A resin composition for stencil ink was prepared in the same manner as in Example 1 except that as the non aqueous dispersion there were used 44 parts of NAD-5 thus obtained instead of 44 parts of NAD-1. The resin composition for stencil ink thus prepared was then processed in the same manner as in Example 1 to obtain a W/O type stencil ink,

Evaluation of Stencil Ink

Subsequently, the stencil ink was examined for misting, fixability and plate drying after printing in the same manner as in Example 1 except that the W/O type stencil ink thus obtained was used The results of evaluation are set forth in Table 1.

### EXAMPLE 6

Preparation of Resin for Dispersing

In a four-neck flask equipped with an agitator, a thermometer, a condenser and a nitrogen gas intake pipe were charged 408 parts of AF Solvent No.7. The solvent was then heated to a temperature of 90° C. Subsequently, to the solvent were added dropwise a mixture of 296 parts of tBMA, 90 parts of 2EHMA, 87 parts of 2EHA and 5 parts of diphenyl-2-methacryloyloxyethyl phosphate and a mixture of 74 parts of AF Solvent No. 7 and 12 parts of BPO in 4 hours. After the termination of dropwise addition, the reaction continued at the same temperature as mentioned above for 8 hours to obtain a transparent acrylic resin solution having a nonvolatile content of 50.0%, a Gardner viscosity of Z-Z₁ at 25° C. and an SP value of 8.0.

Preparation of Non-aqueous Dispersion

In another four-neck flask were charged 771 parts (solid content: 386) of the acrylic resin thus obtained and 22 parts of AF Solvent No. 7. The mixture was then heated to a temperature of 100° C. Subsequently, to the mixture were added dropwise a mixture of 86 parts of MMA and 77 parts of BA (copolymer comprising the mixture of MMA and BA has an SP value of B. 9 and Tg of 7° C.) and a mixture of 38 parts of AF Solvent No. 7 and 1 part of BPO in 4 hours. Thereafter, the mixture was allowed to undergo reaction at the same temperature as mentioned above for 8 hours to obtain a non-aqueous dispersion (NAD-6) having a resin for dispersing/dispersed particulate resin solid weight ratio of 2.3/1, a nonvolatile content of 55.0% and a viscosity of Z₅-Z₆. The non-aqueous dispersion (NAD-5) comprised a core-shell type dispersed particulate resin having an average diameter of 0.7 μm as measured by light scattering method. The iodine value of the resin component comprising the resin for dispersing and the dispersed particulate resin in combination was 2.

Preparation of Resin Composition for Stencil Ink and Stencil Ink

A resin composition for stencil ink was prepared in the same manner as in Example 1 except that as the non-aqueous dispersion there were used 44 parts of NAD-6 thus obtained instead of 44 parts of NAD-1. The resin composition for stencil ink thus prepared was then processed in the same manner as in Example 1 to obtain a W/O type stencil ink.

Evaluation of Stencil Ink

Subsequently, the stencil ink was examined for misting, fixability and plate drying after printing in the same manner as in Example 1 except that the W/O type stencil ink thus obtained was used. The results of evaluation are set forth in Table 1.

### EXAMPLE 7

Preparation of Resin for Dispersing

A transparent acrylic resin solution having a nonvolatile content of 50.0%, a Gardener viscosity of Z₂-Z₃ at 25° C. and an SP value of 8.0 was obtained in the same manner as in Example 1 except that 285 parts of tBMA and 23 parts of the alkyd resin ALK-1 obtained in Example 4 were used instead of 300 parts of tBMA.

Preparation of Non-aqueous Dispersion

A non-aqueous dispersion (NAD-7) having a resin for dispersing/dispersed particulate resin solid weight ratio of 1/1, a nonvolatile content of 55.0% and a viscosity of Z₂ was obtained in the same manner as in Example 1 except that as the resin for dispersing there were used 550 parts of the dispersing acrylated alkyd resin thus obtained instead of 550 parts of the acrylic resin solution. The non-aqueous dispersion (NAD-7) comprised a core-shell type dispersed particulate resin having an average diameter of 0.8 μm as Measured by light scattering method. The iodine value of the resin component comprising the resin for dispersing and the dispersed particulate resin in combination was 2.

Preparation of Resin Composition for Stencil Ink and Stencil Ink

A resin composition for stencil ink was prepared in the same manner as in Example 1 except that as the non-aqueous dispersion there were used 44 parts of NAD-7 thus obtained instead of 44 parts of NAD-1. The resin composition for stencil ink thus prepared was then processed in the same manner as in Example 1 to obtain a W/O type stencil ink.

Evaluation of Stencil Ink

Subsequently, the stencil ink was examined for misting, fixability and plate drying after printing in the same manner as in Example 1 except that the W/O type stencil ink thus obtained was used. The results of evaluation are set forth in Table 1.

### EXAMPLE 8

Preparation of Alkyd Resin

In a four-neck flask equipped with an agitator, a thermometer, a condenser and a nitrogen gas intake pipe were charged 336 parts of coconut oil, coconut oil fatty acid, 294 parts of pentaerythritol and 387 parts of phthalic anhydride, The mixture was then gradually heated to a temperature of 240° C. so that the reaction proceeded while water was being removed until the acid value thereof reached 5 mgKOH/g. Subsequently, to the reaction solution were added 790 parts of AF Solvent No. 7 to obtain an alkyd resin hating a nonvolatile content of 65% (ALK-2).

Preparation of Resin Composition for Stencil Ink and Stencil Ink

Subsequently, 7 parts of the non-aqueous dispersion NAD-1 and 93 parts of the alkyd resin ALK-2 thus obtained were mixed to obtain a resin composition for stencil ink (MG-1) 38 parts of the resin composition for stencil ink MG-1 thus obtained, 10 parts of MA-100, 26 parts of AF Solvent No. 5 and 6 parts of Nikkol SO-10 (sorbitan monooleate as W/O emulsifying agent produced by Nikko chemicals Co. Ltd.) were thoroughly mixed, and then thoroughly kneaded over a three-roll mill to prepare a resin composition for stencil ink (oil phase). Subsequently, to the resin composition for stencil ink was added an aqueous phase comprising 1 part of magnesium sulfate and 119 parts of ion-exchanged water with stirring to cause emulsification, Thus, a W/O type stencil ink was obtained.

Evaluation of Stencil Ink

Subsequently, the stencil ink was examined for misting, fixability and plate drying after printing in the same manner as in Example 1 except that the W/O type stencil ink thus obtained was used. The results of evaluation are set forth in Table 1.

### COMPARATIVE EXAMPLE 1

Preparation of Resin Composition for Stencil Ink and Stencil Ink

A resin composition for stencil ink was prepared in the same manner as in Example 1 except that 37 parts of the alkyd resin ALK-2 obtained in Example 7 were used instead of 44 parts of the non-aqueous dispersion NAD-1 and the amount of AT Solvent No. 5 to be used was changed from 20 parts to 27 parts. The resin composition for stencil ink thus prepared was then processed in the same manner as in Example 1 to obtain a W/O type stencil ink.

Evaluation of Stencil Ink

Subsequently, the stencil ink was examined for misting, fixability and plate drying after printing in the same manner as in Example 1 except that the W/O type stencil ink thus obtained was used. The results of evaluation are set forth in Table 1.

### COMPARATIVE EXAMPLE 2

Preparation of Resin Composition for Stencil Ink and Stencil Ink

37 parts of the alkyd resin ALK-2 obtained in Example 7, 10 parts of MA-100, 27 parts of AF Solvent No. 5 and 6 parts of Nikkol Decaglin 50 were thoroughly mixed, and then thoroughly kneaded over a three-roll mill to prepare a resin composition for stencil ink (oil phase). Subsequently, to the resin composition for stencil ink was added an aqueous phase comprising 1 part of magnesium sulfate, 18 parts of Boncoat 5453 (O/W type acryl emulsion having a nonvolatile content of 55% produced by DAINIPPON INK & CHEMICALS INC.) and 101 parts of ion-exchanged water with stirring to cause emulsification. Thus, a W/O type stencil ink containing an O/W type acryl emulsion was obtained.

Evaluation of Stencil Ink

Subsequently, the stencil ink was examined for misting, fixability and plate drying after printing in the same manner as in Example 1 except that the W/O type stencil ink thus obtained was used. The results of evaluation are set forth in Table 1.

### COMPARATIVE EXAMPLE 3

Preparation of Non-aqueous Dispersion

In a four-neck flask were charged 771 parts (solid content: 386 parts) of the acrylic resin obtained in Example 1 and 209 parts of AF Solvent No.7. The mixture was then heated to a temperature of 100° C. Subsequently, to the solvent mixture were added dropwise a mixture of 165 parts of MMA, 216 parts of BA and 5 parts of divinylbenzene (hereinafter referred to as “DVB”) and a mixture of 30 parts of AY Solvent No. 7 and 1 part of BPO in 4 hours. After the termination of dropwise addition, the reaction continued at the same temperature as mentioned above for 6 hours to obtain a crosslinked non-aqueous dispersion (NAD-1′) having a resin for dispersing/dispersed particulate resin solid weight ratio of 1/1, a nonvolatile content of 55.0% and a viscosity of Z₃-Z₄. The non-aqueous dispersion (NAD-1 ) comprised a core-shell type dispersed particulate resin having an average diameter of 0.8 μm as measured by light scattering method. The iodine value of the resin component comprising the resin for dispersing and the dispersed particulate resin in combination was 2.

Preparation of Resin Composition for Stencil Ink and Stencil Ink

A resin composition for stencil ink was prepared in the saint manner as in Example 1 except that 44 parts of the crosslinked non-aqueous dispersion NAD-1′ were used instead of 44 parts of the non-aqueous dispersion NAD-1. The resin composition for stencil ink thus prepared was then processed in the same manner as in Example 1 to obtain a W/O type stencil ink.

Evaluation of Stencil Ink

Subsequently, the stencil ink was examined for misting fixability and plate drying after printing in the same manner as in Example 1 except that the W/O type stencil ink thus obtained was used. The results of evaluation are set forth in Table 1.

TABLE 1

| Example No. | Misting | Fixability | Drum drying |
|---|---|---|---|
| Example 1 | G | G | G |
| Example 2 | G | G | G |
| Example 3 | G | G | G |
| Example 4 | G | G | G |
| Example 5 | G | G | G |
| Example 6 | G | G | G |
| Example 7 | G | G | G |
| Example 8 | G | G | G |
| Comparative | G | P | G |
| Example 1 | | | |
| Comparative | P | G | P |
| Example 2 | | | |
| Comparative | G | P | G |
| Example 3 | | | |

As can be seen in the foregoing results, the W/O type stencil inks of Examples 1 to 8, which each comprise a resin composition for stencil ink of the invention, exhibit an improved fixability as compared with the stencil ink of Comparative Example 1, which is free of non-aqueous dispersion, and the stencil ink of Comparative Example 3, which comprises a crosslinked non-aqueous dispersion, and is not subject to misting during printing and drum drying as compared with the stencil ink of Comparative Example 2, which comprises an O/W type acryl emulsion.

As mentioned above, the use of the resin composition for stencil ink of the invention makes it possible to obtain a water-in-oil (W/O) type stencil ink which exhibits an improved fixability without causing plate drying and misting.

While the invention has been described in detail and with reference to specific embodiments thereof, it will be apparent to one skilled in the art that various changes and modifications can be made therein without departing from the spirit and scope thereof.

What is claimed is:

1. A resin composition for stencil ink comprising:
(I) a non-aqueous dispersion comprising: (a) a resin for dispersing, (b) a particulate resin comprising a film-forming linear acrylic resin; and (c) at least one solvent that can dissolve said resin (a) therein but cannot dissolve said particulate resin (b) therein, said solvent being selected from the group consisting of paraffinic hydrocarbon solvents, isoparaffinic hydrocarbon solvents and naphthenic hydrocarbon solvents;
(II) a colorant; and
(III) an emulsifying agent.

2. The resin composition according to claim 1, wherein said resin (a) is a resin having a solubility parameter (SP value) of from 7.0 to 8.8 (cal/Ml)^{½} and said particulate resin (b) comprises a linear acrylic resin having a glass transition temperature of from −20° C. to 50° C.

3. The resin composition according to claim 2, wherein said resin (a) is an acrylic resin, acrylated alkyd resin or alkyd resin.

4. The resin composition according to claim 2, wherein said resin (a) is an acrylic resin or acrylated; alkyd resin, containing an amino group, an amide bond or a phosphoric acid ester group.

5. The resin composition according to claim 2, wherein said resin (a) is an acrylic; resin comprising at least 80% by weight of a (meth)acrylic acid alkylester the alkyl moiety of which has from 4 to 13 carbon atoms, or an acrylated alkyd resin comprising from 80 to 95% by weight of a (meth)acrylic acid alkylester the alkyl moiety of which has from 4 to 13 carbon atoms.

6. The resin composition according to claim 1 or 2, wherein said non-aqueous dispersion (I) is a non-aqueous emulsion containing a core-shell dispersed particulate resin,
wherein said core-shell dispersed resin particle comprises:
a core comprising said particulate resin (b); and
a shell comprising said resin (a), and
wherein said non-aqueous emulsion is obtained by a process comprising:
radically polymerizing a monomer, which can be dissolved in said solvent (c) but a resin obtained by the polymerization of which monomer cannot dissolved therein, in the presence of said solvent (c) and said dispersing resin (a) dissolved in said solvent (c).

7. The resin composition according to claim 6, wherein the weight ratio ((a)/(b)) of said resin (a) to said particulate resin (b) is from 0.4/1 to 4/1, and said core-shell dispersed particulate resin dispersed in said non-aqueous dispersion (1) has an average particle diameter of from 0.05 to 3 m as determined by a light scattering method.

8. The resin composition according to claim 6, wherein said core-shell dispersed particulate resin dispersed in said non-aqueous dispersion (I) has an average particle diameter of from 0.3 to 2 μm as determined by a light scattering method.

9. The resin composition according to claim 1 or 2, wherein the sum of iodine values of said dispersing resin (a) and said particulate resin (b) in said non-aqueous dispersion (I) is not greater than 100.

10. The resin composition according to claim 6, wherein said solvent (c) is a mixture of a paraffinic hydrocarbon solvent and a naphthenic hydrocarbon solvent.

11. The resin composition according to any one of claims 1 to 5, wherein said colorant (II) is a pigment, and said emulsifying agent (III) is a nonionic surface active agent.

12. A water-in-oil stencil ink comprising a resin composition according to claim 1 and water.
